(19) United States
(12) Patent Application Publication
(10) Pub. No.: US 2015/0022726 A1
(43) Pub. Date: Jan. 22, 2015

(54) IMAGE PROCESSING APPARATUS AND IMAGE PROCESSING METHOD

(71) Applicant: CANON KABUSHIKI KAISHA, Tokyo (JP)

(72) Inventor: Naoki Kojima, Yokohama-shi (JP)

(21) Appl. No.: 14/325,445

(22) Filed: Jul. 8, 2014

(30) Foreign Application Priority Data
Jul. 19, 2013 (JP) 2013-150987
Apr. 18, 2014 (JP) 2014-086802

(51) Int. Cl. H04N 9/31

(52) U.S. Cl. CPC H04N 9/3185; H04N 9/3182
USPC 348/745

(57) ABSTRACT

Image data is acquired. Information about the shape of the projection plane of an image to be projected by a projection unit is acquired. Projection data to be used for projection is generated using the acquired image data and the acquired information.

### BACKGROUND OF THE INVENTION

1. Field of the Invention

The present invention relates to a technique of generating a video to be projected.

2. Description of the Related Art

To view a video projected by a video projection apparatus on any projection plane, a video projection apparatus having a distortion correction function has been proposed. When distortion is corrected, a viewer can view a video without perceiving distortion even when the projection plane has a curved surface of a column, dome, or the like.

As image quality adjustment after distortion correction, brightness adjustment is demanded in addition to distortion correction. However, depending on the shape of the projection plane, brightness varies because of the difference in the incident angle of the video projected by the video projection apparatus with respect to the projection plane. More specifically, when a video is projected onto a column, the peripheral portion becomes darker than the central portion. To solve this problem, a video projection apparatus capable of correcting luminance as well as distortion has been proposed (Japanese Patent Laid-Open No. 2004-349979).

In Japanese Patent Laid-Open No. 2004-349979, a luminance correction value is estimated from the angle made by the projection plane and the optical axis of the video projection apparatus. However, when a video having a large size is projected onto the curved surface of a column or the like, the angle largely changes depending on the pixel, resulting in luminance unevenness. However, no correction means for each pixel is taken into consideration. In addition, there is no mention of how to know the angle.

### SUMMARY OF THE INVENTION

The present invention has been made in consideration of the above-described problem, and provides a technique of enabling projection of a video in which distortion or luminance unevenness is corrected even when a projection plane is curved.

According to the first aspect of the present invention, an image processing apparatus for generating projection data based on image data, comprising: an image acquisition unit configured to acquire the image data; an information acquisition unit configured to acquire information about a shape of a projection plane of an image to be projected by a projection unit; and a generation unit configured to generate the projection data to be used for projection using the image data acquired by said image acquisition unit and the information acquired by said information acquisition unit.

According to the second aspect of the present invention, an image processing method of generating projection data based on image data, comprising: an image acquisition step of acquiring the image data; an information acquisition step of acquiring information about a shape of a projection plane of an image to be projected by a projection unit; and a generation step of generating the projection data to be used for projection using the image data acquired in the image acquisition step and the information acquired in the information acquisition step.

According to the third aspect of the present invention, a computer-readable storage medium storing a program that causes a computer to generate projection data based on image data, the program comprising: an image acquisition step of acquiring the image data; an information acquisition step of acquiring information about a shape of a projection plane of an image to be projected by a projection unit; and a generation step of generating the projection data to be used for projection using the image data acquired in the image acquisition step and the information acquired in the information acquisition step.

Further features of the present invention will become apparent from the following description of exemplary embodiments with reference to the attached drawings.

### BRIEF DESCRIPTION OF THE DRAWINGS

FIG. 1 is a block diagram showing an example of the functional arrangement of a video generation apparatus 100;

FIGS. 2A to 2D are views for explaining an image coordinate system, a projection range, and a coordinate transformation operator;

FIG. 3 is a flowchart of processing performed by the video generation apparatus 100;

FIG. 4 is a block diagram showing an example of the functional arrangement of a video generation apparatus 400 and a video projection apparatus 410;

FIG. 5 is a block diagram showing an example of the functional arrangement of a video generation apparatus 500;

FIG. 6 is a view for explaining an overlapping portion 601;

FIG. 7 is a block diagram showing an example of the functional arrangement of a video generation apparatus 700;

FIG. 8 is a view showing a display example of a GUI;

FIG. 9 is a block diagram showing an example of the arrangement of a system according to the fifth embodiment;

FIG. 10 is a view showing an example of measurement by a measurement apparatus 910;

FIG. 11 is a block diagram showing an example of the hardware arrangement of a computer;

FIG. 12 is a view showing the concept of projection to a concave surface; and

FIG. 13 is a view showing an example of a UI configured to select a projection plane.

### DESCRIPTION OF THE EMBODIMENTS

Embodiments of the present invention will now be described with reference to the accompanying drawings. Note that the embodiments to be described below are examples of detailed implementation of the present invention and detailed examples of the arrangement described in the appended claims.

### First Embodiment

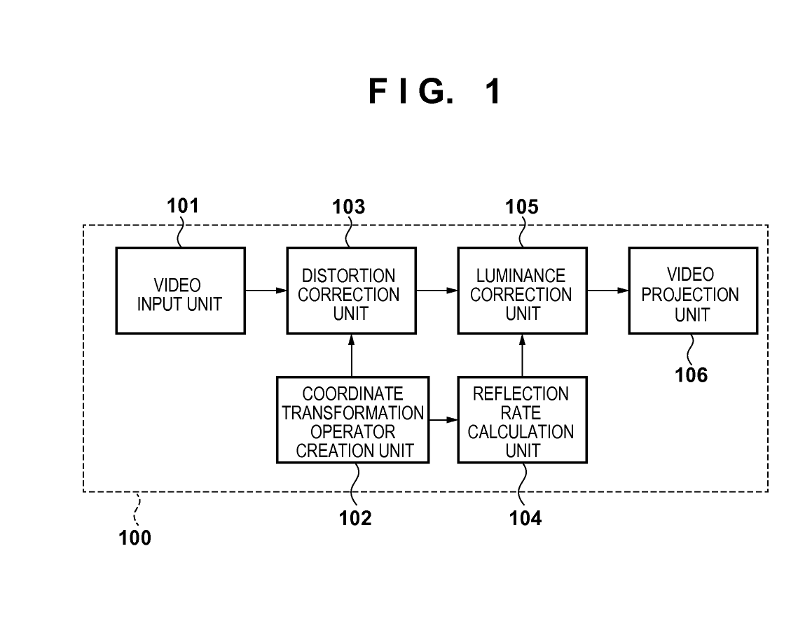

An example of the functional arrangement of a video generation apparatus 100 according to this embodiment will be described first with reference to the block diagram of FIG. 1. Note that FIG. 1 only illustrates major components used to perform processing to be described below.

A video input unit 101 inputs an original video (input video). A distortion correction unit 103 generates a projection video by correcting distortion in the input video using a coordinate transformation operator generated by processing (to be described later) of a coordinate transformation operator creation unit 102. A luminance correction unit 105 corrects luminance components in the projection video generated by the distortion correction unit 103 using a reflection rate calculated by processing (to be described later) of a reflection rate calculation unit 104. A video projection unit 106 projects the projection video whose luminance components have been corrected by the luminance correction unit 105 onto an appropriate screen. Note that the output destination of the projection video whose luminance components have been corrected is not limited to this, and may be a memory or a device provided in or outside the apparatus.

Processing for generating a coordinate transformation operator by the coordinate transformation operator creation unit 102 will be described next in detail. Assume that an input video is projected onto, for example, a column without any transformation. Since the projection plane is curved, the video projected onto the curved surface looks distorted, as a matter of course. In this embodiment, the input video is transformed in advance so the video projected onto the curved surface does not look distorted. The coordinate transformation operator creation unit 102 generates information necessary for this transformation as a coordinate transformation operator f( ).

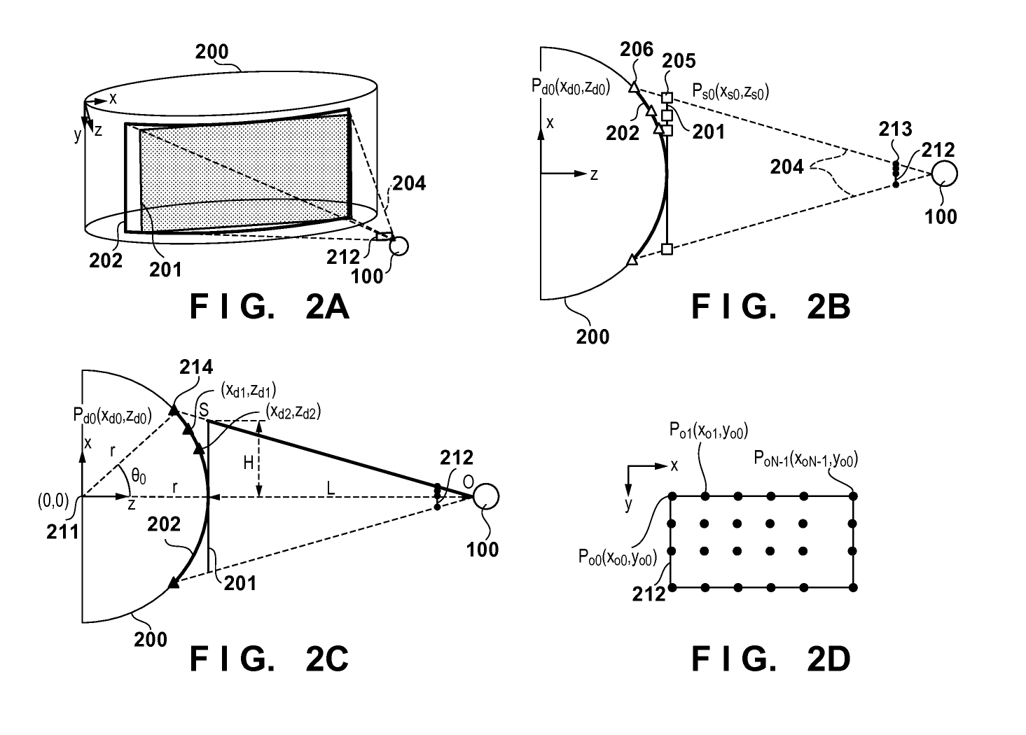

How the distortion occurs and the coordinate transformation operator f( ) will be explained below with reference to FIGS. 2A to 2D. In this embodiment, a description will be made assuming that the video projection destination (screen) is a column, as shown in FIGS. 2A to 2D, for the descriptive convenience.

FIG. 2A is a conceptual view of projection of a video to a columnar screen 200. A projection range 202 is the projection range on the screen 200. A projection range 201 is the projection range on a flat screen assumed to be placed in contact with the screen 200. A projection optical system belonging to the video projection unit 106 is designed assuming that it can project an undistorted video on the projection range 201. When the undistorted video projected on the projection range 201 is projected on the projection range 202, the video is distorted. Details will be described with reference to FIGS. 2D and 2B.

FIG. 2D shows an image coordinate system 212. The image coordinate system 212 is formed from an x-axis in the horizontal direction and a y-axis in the vertical direction. The coordinate system of a video input from the video input unit 101 complies with this coordinate system. More specifically, the pixel position at the upper left corner of the input video has coordinates Po0(xo0, yo0), the adjacent pixel position immediately on the right has coordinates Po1(xo1, yo0), and the pixel position at the right end of this row has coordinates PoN−1(xoN−1, yo0) (when the number of horizontal pixels is N). The pixel at each pixel position has a luminance value.

As shown in FIGS. 2A and 2B, the video projection unit 106 projects the image coordinate system 212 onto the screen 200. FIG. 2B is a view showing the space shown in FIG. 2A along the xz plane. The origin of the xz plane is set at the center of the column.

Reference numeral 204 denotes a diffusion direction (range) of light projected from the video projection unit 106. A pixel sequence 213 (plot of filled circles) is the pixel sequence on the image coordinate system 212. The video projection unit 106 projects the pixel sequence 213 as a pixel sequence 205 (plot of squares) on the projection range 201 and as a pixel sequence 206 (plot of triangles) on the projection range 202. The positions of the respective pixels of the pixel sequence 205 (plot of squares) are the projection positions of the respective pixel positions on the image coordinate system 212 when the pixel sequence is assumed to be projected on the projection range 201. The positions of the respective pixels of the pixel sequence 206 (plot of triangles) are the projection positions of the respective pixel positions on the image coordinate system 212 when the pixel sequence is projected on the projection range 202. Note that the pixel sequences 213, 205, and 206 are pixel sequences in the x direction. In fact, similar pixel sequences exist in the y direction as well.

As shown in FIGS. 2B and 2C, the coordinate position, on the xz plane, of each point on the projection range 202 that is an arc is represented by Pd(xd, zd). The coordinate position, on the xz plane, of each point on the projection range 201 is represented by Ps(xs, zs). A position at which the pixel having the maximum x-coordinate value out of the pixel sequence 213 is projected on the projection range 201 is represented by Ps0(xs0, zs0). A position at which the pixel having the maximum x-coordinate value out of the pixel sequence 213 is projected on the projection range 202 is represented by Pd0(xd0, zd0).

When the video projection unit 106 projects the image coordinate system 212 on the projection range 201, the image coordinate system 212 and the projection range 201 are parallel, and the pixel interval in the pixel sequence 205 does not change depending on the pixel position, like the pixel sequence 213, and no distortion occurs. On the other hand, when the video projection unit 106 projects the image coordinate system 212 on the projection range 202, the pixels diffuse outward in accordance with the diffusion direction 204 of light. Hence, the pixel interval becomes large outward in the pixel sequence 206, and this is visually recognized as distortion.

In this embodiment, to correct the distortion, the following processing is performed. A method of obtaining a coordinate transformation operator that is information (correspondence relationship information) representing the correspondence relationship between a position on the projection range 202 and a position on the projection range 201 will be described first. The coordinate transformation operator creation unit 102 obtains a coordinate transformation operator in accordance with a procedure to be described below.

On the xz plane shown in FIG. 2C, the center (center of a coordinate system 211) of the screen 200 that is a column is assumed to be placed at (x, z)=(0, 0). In this case,

$$\begin{matrix}{x}_{d}^{2} + {x}_{d}^{2} = {r}^{2} \\ and & ( 1 ) \\ {z}_{d} = - \frac{L}{H} {x}_{d} + ( r + L ) & ( 2 )\end{matrix}$$

hold.

Equation (1) is the equation of a circle including the projection range 202. Equation (2) is the equation of a line SO including the diffusion direction 204 (O is the position of the video projection unit 106, and S indicates the position Ps0(xs0, zs0)). In these equations, r is the radius of the screen 200 that is a column, and L is the distance from the position of the video projection unit 106 to the screen 200. In addition, H is the half of the length of the projection range 201 in the x direction. H can be obtained from the distance L and the diffusion direction 204. Alternatively, a value corresponding to the distance L and the diffusion direction 204, that is, the characteristic of the optical system of the video projection unit 106 may be stored in the video projection unit 106 in advance. From equations (1) and (2), equations (3) to (5) can be obtained. As a result, the coordinate transformation operator f( ) can be obtained.

$$\begin{matrix}{x}_{d} = f ( {x}_{s} ) = \frac{αβ \pm \sqrt{{r}^{2} ( 1 + {α}^{2} ) + {β}^{2}}}{( 1 + {α}^{2} )} & ( 3 ) \\ α and β are given by \\ α = \frac{L}{H} & ( 4 ) \\ β = r + L & ( 5 )\end{matrix}$$

When xs=H, equations (3) to (5) are used to specify the position xd on the projection range 202 corresponding to xs. When xs=h (−H<h<H), α=h/L is used to specify the position xd on the projection range 202 corresponding to xs.

The distortion correction unit 103 first obtains x-coordinates xdn (plot of filled triangles in FIG. 2C: n=0, . . . , N−1:N is the number of horizontal pixels) of coordinates Pdn of the respective positions arranged on the projection range 202 at an equal interval. To do this, first, an angle θ0 made by the coordinate system 211 and the coordinates Pd0 of an end 214 of the projection range 202 that is an arc is obtained. The angle θ0 can be obtained by calculating

$${θ}_{0} = {sin}^{- 1} \frac{{x}_{d 0}}{r} \qquad ( 6 )$$

Note that the x-coordinate xd0 of the coordinates Pd0 is obtained from the x-coordinate xs0 (image end) of the coordinates Ps0 using the coordinate transformation operator f( ). Next, θ0 is equally divided by the number of pixels such that the pixels are arranged at an equal interval, and the x-coordinates xdn of the coordinates Pdn are obtained. The x-coordinates xdn of the coordinates Pdn of the respective pixels arranged on the projection range 202 at an equal interval are obtained by calculating

$$\begin{matrix}{x}_{dn} = ABS \{ r sin ( {θ}_{0} - \frac{2}{N} n {θ}_{0} ) \} & ( 7 ) \\ ABS ( x ) = \{ \begin{matrix}- x , & x < 0 \\ x , & x \geq 0\end{matrix} & ( 8 )\end{matrix}$$

Next, the distortion correction unit 103 calculates x-coordinates xsn of coordinates Psn on projection range 201, which correspond to the x-coordinates xdn of the coordinates Pdn obtained by equations (7) and (8). The coordinates are obtained, using the coordinate transformation operator f( ), by calculating

xₛₙ=f⁻¹(x_{dn}) (9)

As described above, the image coordinate system 212 is projected onto the projection range 201. For this reason, the x-coordinates on the image coordinate system 212 corresponding to the x-coordinates on the projection range 201, that is, the x-coordinates on the input video can uniquely be specified. When the x-coordinates xsn are obtained by equation (9), the distortion correction unit 103 obtains pixel values M(Pdn) corresponding to xdn from the luminance values at peripheral pixel positions around the pixel positions on the input video corresponding to xsn (M(x) represents the pixel value at a coordinate x). For example, when xo1<xs1<xo2, a pixel value M(Pd1) can be obtained, using linear interpolation, by calculating

$$M ( {P}_{d 1} ) = ( 1 - \frac{{x}_{s 1} - {x}_{o 1}}{{x}_{o 2} - {x}_{o 1}} ) M ( {P}_{o 1} ) + \frac{{x}_{s 1} - {x}_{o 1}}{{x}_{o 2} - {x}_{o 1}} M ( {P}_{o 2} ) \qquad ( 10 )$$

Note that although linear interpolation is used here as a method of obtaining one pixel value from a plurality of pixel values, the usable method is not limited to linear interpolation, and various other methods such as bicubic interpolation may be employed.

The distortion correction unit 103 thus obtains the pixel values corresponding to the respective positions arranged on the projection range 202 at an equal interval. In other words, the pixel values on one line of the projection video on the xz plane shown in FIGS. 2B and 2C are determined. When the same processing as described above is performed for the respective lines, the pixel values of the pixels on the projection video can be calculated as a result.

Note that a description concerning the y direction will be omitted.

On the other hand, the reflection rate calculation unit 104 calculates the reflection rate. The reflection rate is the ratio of the light amount (reflected light amount) returned to the video generation apparatus 100 to the incident light amount from the video projection unit 106. The reflection rate on the projection range 202 of the screen 200 changes depending on the position in the projection range 202. To obtain the reflection rate, the angle θ0 calculated based on equation (6) by the coordinate transformation operator creation unit 102 is used. A reflection rate R(Pd) for the coordinates Pd is obtained by calculating

$$R ( {P}_{d} ) = {{δ}_{r} ( 1 - \frac{2 {L}_{m}}{π ( L + {L}_{m} )} {θ}_{0} )}^{{γ}_{r}} + {ζ}_{r} \qquad ( 11 )$$

where γr is the acceleration of a change in the reflection rate with respect to θ0, and δr and ζr represent the reflection rate difference between the maximum and minimum values of the angle θ0. For example, γr=3, εr=3/5, and ζr=2/5 are substituted. Lm is the reference value for the projection distance L. For example, Lm=r is substituted. The reflection rate calculation unit 104 changes the reflection rate change amount in accordance with the distance L from the video generation apparatus 100 to the screen 200. For example, when the projection range 202 remains unchanged, equation (11) is calculated such that the reflection rate change amount in the projection range 202 decreases as the distance L increases.

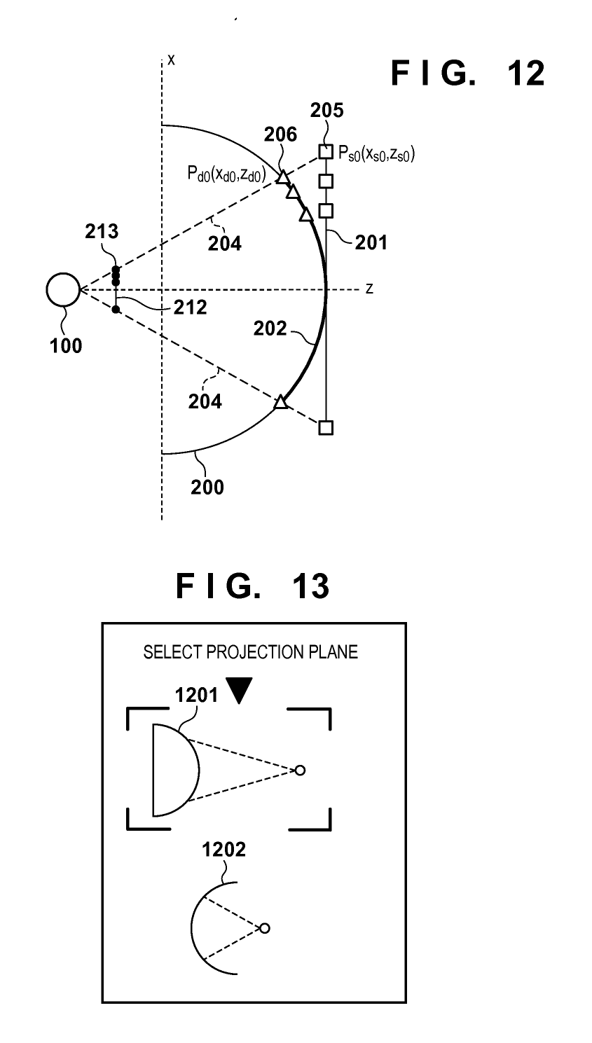

Note that when projection is done from the inside of a cylinder, that is, when a video is projected onto a concave surface that is bowed inward at the center of the projection plane, as shown in FIG. 12, the decrease in luminance at the periphery is small with the same distance L and same radius r. Hence, luminance correction can be a little. Hence, when the projection plane is a concave surface, δr=1/10, ζr=9/10, and the like are substituted. When the coordinates Pd=Pdm(0<m<N−1), θ is m×θ0/N, where θ is the angle with respect to the pixel at the coordinates Pdm on the projection range 202. γr, δr, and ζr are arbitrary constants. For example, γr=2, δr=2/3, and ζr=2/5 are substituted.

Note that the method of obtaining the reflection rate is not limited to the method of obtaining the reflection rate by calculating equation (11), and may be a method of calculating the reflection rate while sequentially looking up a correspondence table of the angle θ and the reflection rate as a lookup table. A plurality of types of coefficients may be held to cope with a plurality of screen materials having different screen gains, and the coefficient may be switched for each material. In place of a reflected light amount returned to the video generation apparatus 100, a reflected light amount to the viewer position may be used as the reflection rate. In this case, the angle θ0 and the distance L of equation (11) are changed in accordance with the viewer position.

The luminance correction unit 105 obtains a luminance gain G(Pd) from a reflection rate R(Pd) calculated by the reflection rate calculation unit 104 for the coordinates Pd, corrects the pixel value M(Pd) using the obtained luminance gain, and obtains a corrected luminance value C(Pd). Luminance value correction by the luminance correction unit 105 is done by calculating

$$\begin{matrix}C ( {P}_{d} ) = G ( {P}_{d} ) * M ( {P}_{d} ) & ( 12 ) \\ G ( {P}_{d} ) = \frac{{δ}_{g}}{{R ( {P}_{d} )}^{{γ}_{g}}} & ( 13 )\end{matrix}$$

where γg and δg are arbitrary constants. For example, when γg=0.5 and δg=0.9 are substituted, a luminance correction effect can be obtained. The method of calculating the luminance gain is not limited to this. The luminance gain may be calculated while sequentially looking up a correspondence table of the reflection rate and the luminance gain as a lookup table.

The luminance gain G(Pd) may be normalized within the range of the reflection rate R(Pd) calculated in the projection range 202. For example, G(Pd)=1.0 may set for coordinates where the reflection rate R(Pd) is minimum, G(Pd)=0.8 may set for coordinates of the maximum reflection rate, and luminance gains in the intermediate range may be determined by linear interpolation.

Luminance values corresponding to the respective coordinates Pd on the projection video can thus be corrected to C(Pd). Hence, the video projection unit 106 projects the projection video that has undergone luminance correction by the luminance correction unit 105 onto the screen 200.

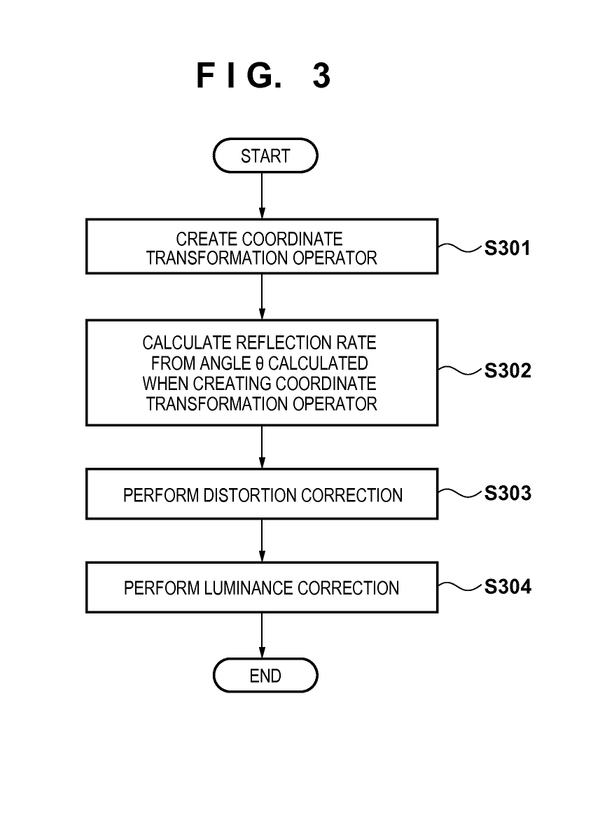

FIG. 3 shows the above-described series of processes. Note that the processing contents in each step of FIG. 3 are the same as described above, and only a brief description will be made here. In step S301, the coordinate transformation operator creation unit 102 generates the coordinate transformation operator f( ). In step S302, the reflection rate calculation unit 104 obtains the reflection rate using θ obtained in the process of calculating the coordinate transformation operator in step S301.

In step S303, the distortion correction unit 103 generates a projection video from the input video using the coordinate transformation operator obtained by the coordinate transformation operator creation unit 102. In step S304, the luminance correction unit 105 corrects the luminance of the projection video generated in step S303 using the reflection rate calculated by the reflection rate calculation unit 104. The reflection rate calculation unit 104 sends the projection video that has undergone the luminance correction to the video projection unit 106.

As described above, according to this embodiment, it is possible to project a video that is free from distortion and has suppressed luminance unevenness onto any projection plane. Note that this embodiment has been described assuming that the screen is a column, as shown in FIG. 2. However, the same effect can be obtained by the same method even in a shape other than the columnar shape, for example, a spherical shape, domelike shape, or flat surface.

Note that the above-described arrangement is merely an example of a basic arrangement to be described below. That is, as the basic arrangement, the video generation apparatus generates, from an input video, a projection video to be projected onto a defined region of a curved surface. In this video generation apparatus, luminance values at pixel positions in the projection video corresponding to the respective positions arranged in the defined region at an equal interval are obtained from luminance values at peripheral pixel positions around the pixel positions in the input video corresponding to the positions. Reflection rates for the positions arranged in the defined region at an equal interval are obtained using parameters that define the respective positions. The luminance values obtained for the positions are corrected using the reflection rates obtained for the positions. The projection video in which the luminance values are corrected is output.

### Second Embodiment

In the first embodiment, an apparatus for projecting a projection video that has undergone luminance correction onto a screen has been described. This apparatus may be divided into an apparatus for performing distortion correction and luminance correction and an apparatus for performing projection.

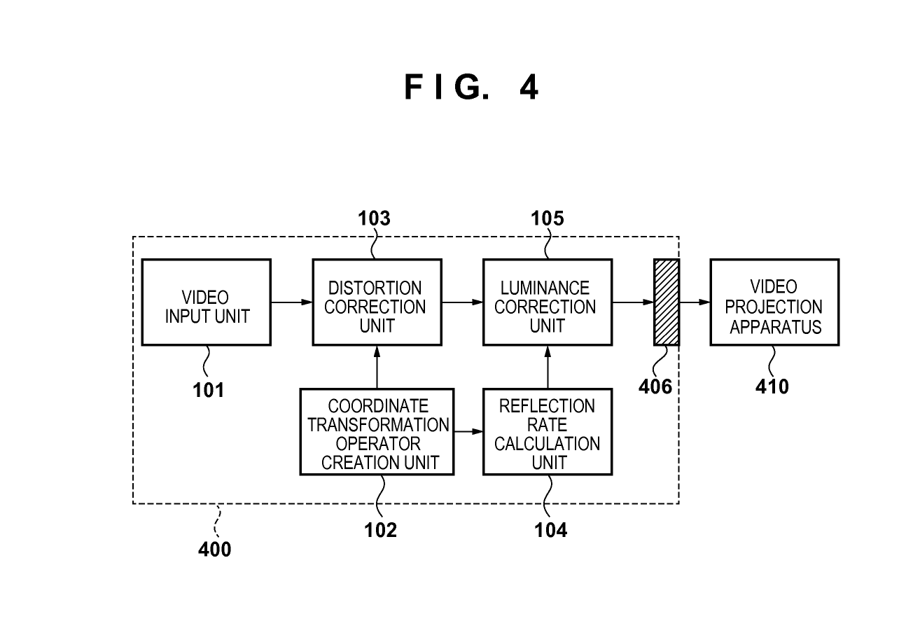

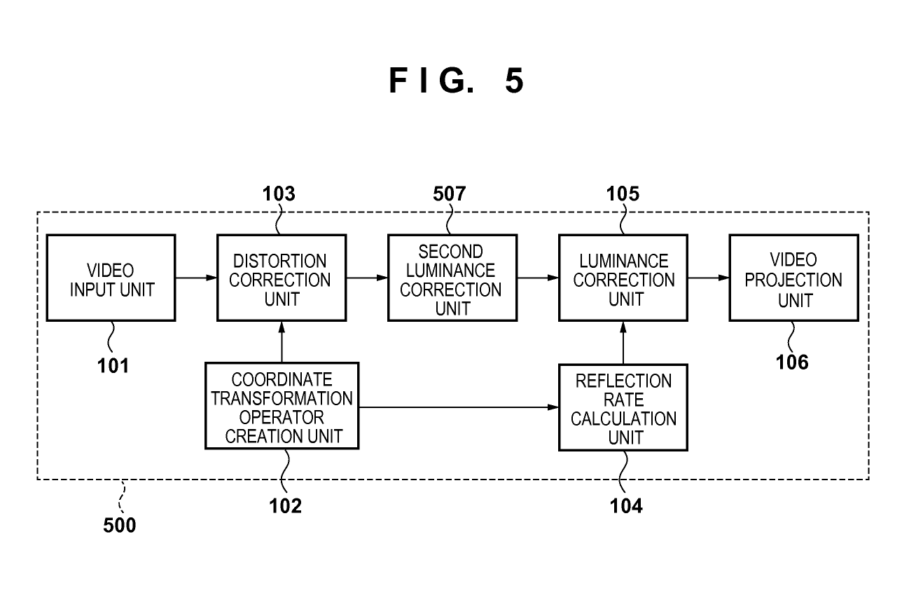

In this case, as shown in FIG. 4, the apparatus is assumed to be divided into an apparatus (video generation apparatus) 400 for performing distortion correction and luminance correction described in the first embodiment, and a video projection apparatus 410 functioning as the above-described video projection unit 106. The video generation apparatus 400 includes a video interface 406 configured to connect the video projection apparatus 410, and sends a video that has undergone luminance correction by a luminance correction unit 105 to the video projection apparatus 410. The standard used by the video interface 406 can be, for example, DVI (Digital Visual Interface) or HDMI® (High Definition Multimedia Interface).

### Third Embodiment

In this embodiment, a video generation apparatus applicable to a multiprojection system that makes overlapping portions between projection videos unnoticeable by luminance correction will be described. FIG. 5 shows an example of the functional arrangement of a video generation apparatus according to this embodiment.

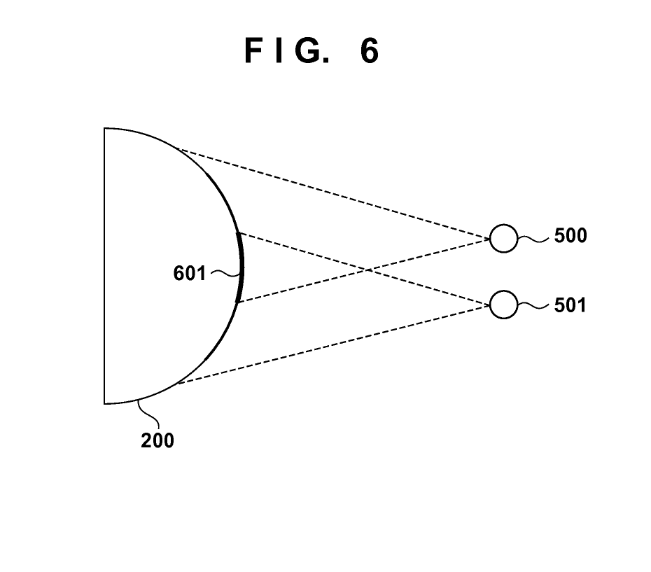

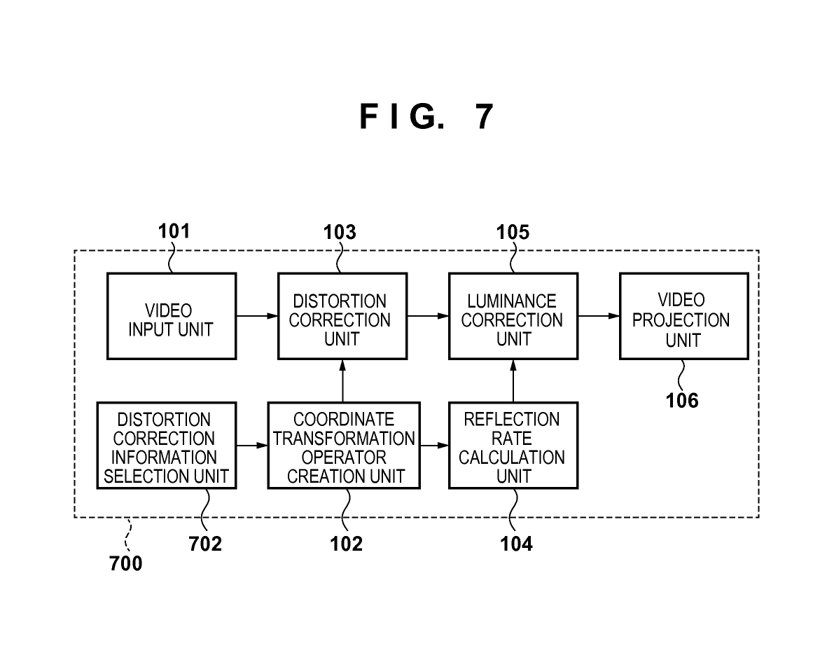

As shown in FIG. 6, when an overlapping portion 601 is formed between a video projected from a video generation apparatus 500 and a video projected from a video generation apparatus 501 adjacent to the video generation apparatus 500, the video generation apparatus 500 corrects the luminance of the overlapping portion 601 so as to make the overlapping portion unnoticeable. FIG. 5 illustrates an example of the functional arrangement of the video generation apparatus 500 at that time.

As shown in FIG. 5, the video generation apparatus 500 is formed by adding a second luminance correction unit 507 to the arrangement shown in FIG. 1. The second luminance correction unit 507 lowers the luminance of the overlapping portion 601 by a predetermined amount. Note that the video generation apparatus 501 can be a video generation apparatus as described in the first embodiment or another video generation apparatus capable of projecting a video.

### Fourth Embodiment

The video generation apparatus according to the first embodiment may be configured to cause the user to select distortion correction information and estimate, based on the selection result, the surface shape of the projection plane on which a projection video is to be projected. In this embodiment, a video generation apparatus having such an arrangement will be described.

FIG. 7 shows an example of the functional arrangement of a video generation apparatus according to this embodiment. As shown in FIG. 7, a video generation apparatus 700 according to this embodiment is formed by adding a distortion correction information selection unit 702 to the arrangement shown in FIG. 1.

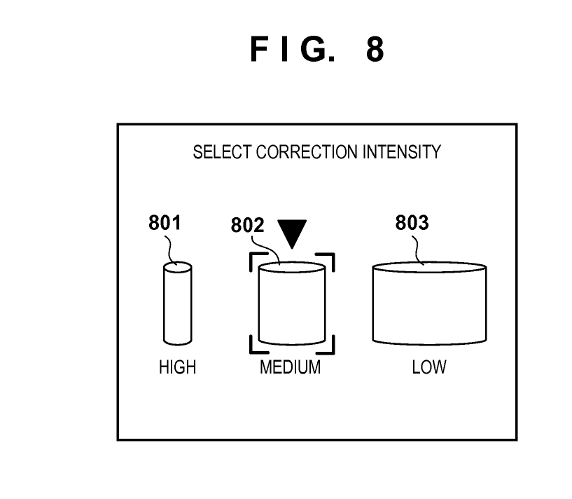

The distortion correction information selection unit 702 causes the user to input the projection plane shape, that is, a convex surface or concave surface, and the intensity of distortion correction. For example, the distortion correction information selection unit 702 displays, on the display screen, a GUI (Graphical User Interface) configured to cause the user to input the distortion correction intensity, and acquires the distortion correction intensity input by the user who has confirmed the display screen. For example, a GUI as shown in FIG. 8 or 13 is displayed. The GUI shown in FIG. 8 is configured to cause the user to select one of “high” (highest distortion correction intensity), “medium” (second highest distortion correction intensity), and “low” (lowest distortion correction intensity). This GUI is merely an example, as a matter of course. Distortion correction intensities of three or more levels or less than three levels may be inputtable. Various GUIs such as a button and a slider are considerable, as a matter of course. The user may be allowed to select a concave surface or convex surface and the distortion correction intensity by one GUI.

In the GUI shown in FIG. 8, icons 801, 802, and 803 are used to designate “high”, “medium”, and “low” distortion correction intensities, respectively. For example, when the user selects the icon 803 (“low”) out of the icons 801, 802, and 803, the distortion correction information selection unit 702 sets r1 (predetermined value) as a radius r described above. When the user selects the icon 802 (“medium”), the distortion correction information selection unit 702 sets r2 (r1>r2) as the radius r. When the user selects the icon 801 (“high”), the distortion correction information selection unit 702 sets r3 (r2>r3) as the radius r. When r is changed in accordance with the selection result in this way, the value θ0 changes. As a result, the distortion correction intensity changes. The luminance correction intensity also changes by extension. Note that since r1>r2>r3, the lower the distortion correction intensity is, the larger the radius r of the assumed column is.

In the GUI shown in FIG. 13, icons 1201 and 1202 are used to designate projection onto a convex surface and projection onto a concave surface, respectively. Values δr and ζr in equation (11) are changed in accordance with the selection result of the icons 1201 and 1202. Note that a decrease in the luminance in the periphery of the projection plane is small when projection onto a concave surface is performed. Hence, when the icon 1202 is selected, luminance correction may be prohibited.

### Fifth Embodiment

In the first embodiment, a component that measures the positional relationship between the video generation apparatus and the screen and estimates the surface shape of the projection plane from the measured positional relationship may further be added. In this embodiment, a system having such an arrangement will be described.

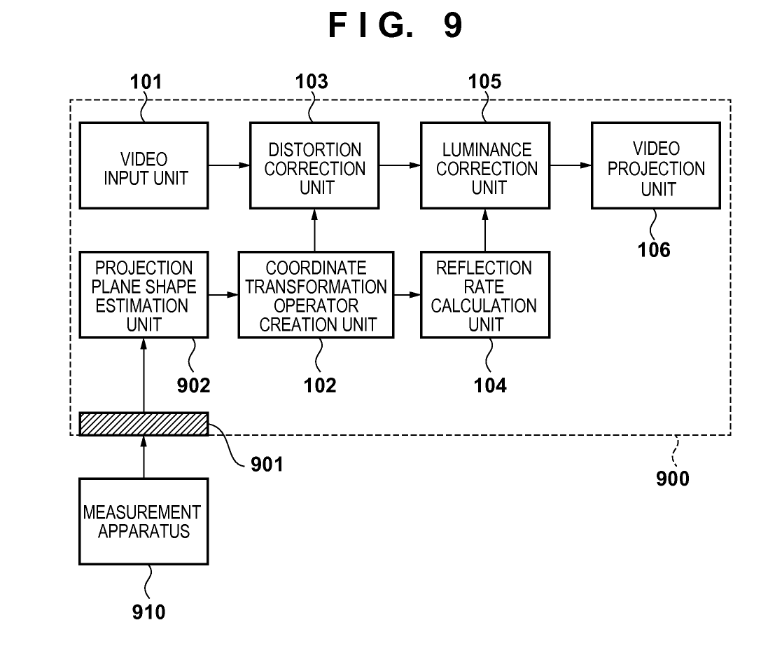

FIG. 9 shows an example of the functional arrangement of a system according to this embodiment. The system according to this embodiment includes a video generation apparatus 900 formed by adding a projection plane shape estimation unit 902 and an interface 901 to the video generation apparatus 100 according to the first embodiment, and a measurement apparatus 910.

The interface 901 functions as an interface configured to connect the measurement apparatus 910 to the video generation apparatus 900. The standard can be, for example, RS232C or USB (Universal Serial Bus).

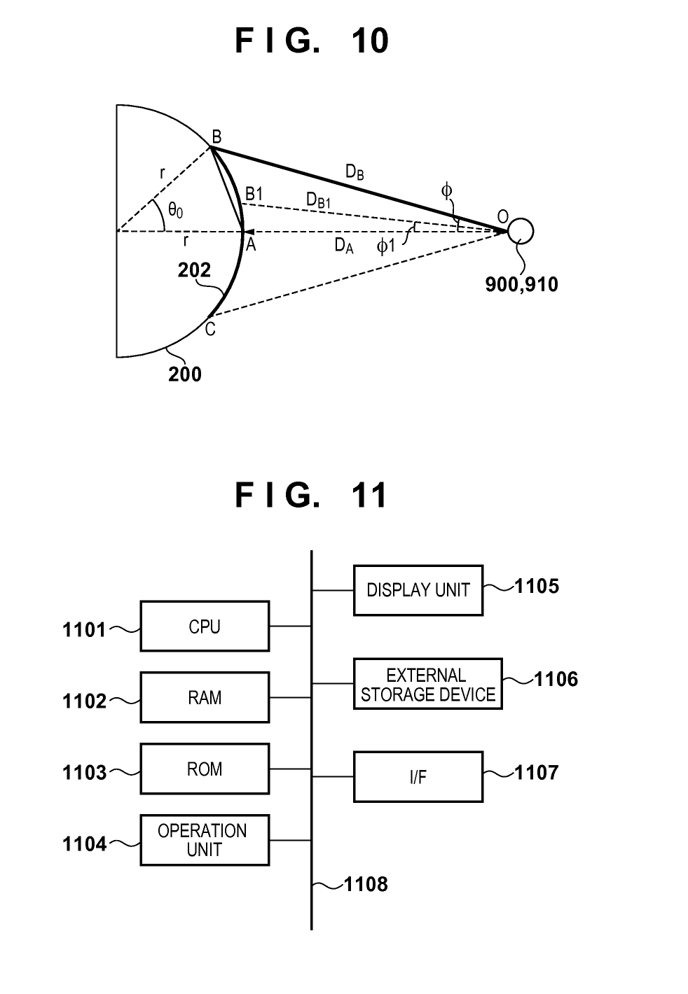

FIG. 10 shows an example of measurement by the measurement apparatus 910. The measurement apparatus 910 can be a laser rangefinder that includes, for example, a light-emitting portion and a light-receiving portion for a laser beam, and measures the distance and angle based on reflection of a laser beam. Referring to FIG. 10, an arc BC corresponds to a projection range 202. To know the shape of a screen 200, a radius r and an angle θ0 are necessary. To obtain them, a length l of the arc AB is necessary. The measurement apparatus 910 measures a distance DB of a line segment OB, a distance DA of a line segment OA, and an angle φ made by the line segments OB and OA. The measurement apparatus 910 also obtains an angle φ1 made by the line segments OA and OB1 at a minimum measurable angle and a length (distance) DB1 of the line segment OB1.

The projection plane shape estimation unit 902 obtains a length 11 of a chord AB1 (∠AOB1 is the minimum measureable unit) from these pieces of information. The projection plane shape estimation unit 902 obtains approximation of l, using l1, φ, and φ1, by calculating

$$l ≅ l 1 \frac{ϕ}{ϕ 1} \qquad ( 14 )$$

The projection plane shape estimation unit 902 obtains the radius r and angle θ0 from the length l of the arc AB, and sends the obtained radius r and angle θ0 to a coordinate transformation operator creation unit 102. The coordinate transformation operator creation unit 102 performs processing as described in the first embodiment using the radius r and angle θ0 obtained from the projection plane shape estimation unit 902, thereby obtaining a coordinate transformation operator. Note that some or all of the arrangements described in the first to fifth embodiments may appropriately be used in combination.

### Sixth Embodiment

In the arrangements shown in FIGS. 1, 4, 5, 7, and 9, the functional units may be formed by hardware. Units except the video projection unit 106 and the video interfaces 406 and 901 may be formed by software. In this case, the arrangements shown in FIGS. 1, 4, 5, 7, and 9 can be implemented by a computer having a hardware arrangement example shown in FIG. 11.

A CPU 1101 executes processing using computer programs and data stored in a RAM 1102 or a ROM 1103, thereby controlling the operation of the entire computer. The CPU 1101 also executes each of the processes described above as processing to be executed by each video generation apparatus.

The RAM 1102 has an area to temporarily store computer programs and data loaded from an external storage device 1106 or data externally received via an I/F (interface) 1107. The RAM 1102 also has a work area to be used by the CPU 1101 to execute various kinds of processing. That is, the RAM 1102 can appropriately provide various kinds of areas.

The ROM 1103 stores the setting data and boot program of the computer.

An operation unit 1104 is formed from a mouse and a keyboard. When operated by the operator of the computer, the operation unit 1104 can input various instructions to the CPU 1101. For example, the user inputs selection of the distortion correction intensity by operating the operation unit 1104.

A display unit 1105 is formed from a CRT or a liquid crystal screen, and can display a processing result of the CPU 1101 by an image or characters. For example, a GUI used to select the distortion correction intensity is displayed on the display unit 1105.

The external storage device 1106 is a mass information storage device represented by a hard disk drive. The external storage device 1106 stores the OS (Operating System) and computer programs and data used to cause the CPU 1101 to execute each of the processes described above as processing to be executed by a video generation apparatus. The computer programs include computer programs used to cause the CPU 1101 to execute each of the processes described above as processing to be executed by the units except the video projection unit 106 and the video interfaces 406 and 901 in the arrangements shown in FIGS. 1, 4, 5, 7, and 9. The data include an input video and data described above as known parameters in various kinds of calculations described above. The computer programs and data stored in the external storage device 1106 are appropriately loaded to the RAM 1102 under the control of the CPU 1101 and processed by the CPU 1101. For example, the above-described video projection apparatus 410 or measurement apparatus 910 can be connected to the I/F 1107. All the above-described units are connected to a bus 1108.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2013-150987, filed Jul. 19, 2013, and 2014-086802, filed Apr. 18, 2014 which are hereby incorporated by reference herein in their entireties.

What is claimed is:

1. An image processing apparatus for generating projection data based on image data, comprising:
an image acquisition unit configured to acquire the image data;
an information acquisition unit configured to acquire information about a shape of a projection plane of an image to be projected by a projection unit; and
a generation unit configured to generate the projection data to be used for projection using the image data acquired by said image acquisition unit and the information acquired by said information acquisition unit.

2. The apparatus according to claim 1, wherein said generation unit changes, out of the image data, image data corresponding to a region where an angle made by the projection plane and a projection direction of the projection unit is not less than a predetermined value for generation of the projection data.

3. The apparatus according to claim 1, wherein when there exist a region where a ratio of a reflected light amount from the projection plane to a projection light amount by the projection unit is less than a threshold, and a region where the ratio is not less than the threshold, said generation unit lowers a luminance of image data corresponding to the region where the ratio is not less than the threshold out of the image data for generation of the projection data.

4. The apparatus according to claim 1, wherein the information is information about a degree of bending of the projection plane, and
when an angle of a center of the projection plane with respect to the projection direction of the projection unit is larger than the angle of an end of the projection plane with respect to the projection direction of the projection unit, said generation unit generates the projection data whose difference from the image data is larger when second information representing a second degree of bending larger than a first degree of bending is acquired than when first information representing the first degree of bending is acquired.

5. The apparatus according to claim 1, further comprising a specifying unit configured to specify an overlapping region between a projection region of the image to be projected by the projection unit and a second projection region by a second projection unit,
wherein said generation unit raises a luminance of image data corresponding to the overlapping region specified by said specifying unit out of the image data for generation of the projection data.

6. The apparatus according to claim 1, further comprising a user interface configured to input the information about the shape of the projection plane,
wherein said information acquisition unit acquires the information according to input to said user interface.

7. The apparatus according to claim 1, further comprising an interface configured to acquire sensor information from a sensor configured to measure a distance from the projection unit to the projection plane,
wherein said information acquisition unit acquires the information about the shape of the projection plane based on the sensor information acquired from the sensor.

8. The apparatus according to claim 1, wherein said information acquisition unit acquires, as the information about the shape of the projection plane, correspondence relationship information representing a correspondence relationship between coordinates on the projection plane and coordinates on a plane perpendicular to a projection direction of the projection unit.

9. The apparatus according to claim 1, wherein when the projection unit projects the image onto a column, said information acquisition unit acquires information about a distance from the projection unit to the projection plane and information representing a radius of the column as the information about the shape of the projection plane.

10. An image processing method of generating projection data based on image data, comprising:
an image acquisition step of acquiring the image data;
an information acquisition step of acquiring information about a shape of a projection plane of an image to be projected by a projection unit; and
a generation step of generating the projection data to be used for projection using the image data acquired in the image acquisition step and the information acquired in the information acquisition step.

11. The method according to claim 10, wherein in the generation step, out of the image data, image data corresponding to a region where an angle made by the projection plane and a projection direction of the projection unit is not less than a predetermined value is changed for generation of the projection data.

12. The method according to claim 10, wherein when there exist a region where a ratio of a reflected light amount from the projection plane to a projection light amount by the projection unit is less than a threshold, and a region where the ratio is not less than the threshold, in the generation step, a luminance of image data corresponding to the region where the ratio is not less than the threshold out of the image data is lowered for generation of the projection data.

13. The method according to claim 10, wherein the information is information about a degree of bending of the projection plane, and
when an angle of a center of the projection plane with respect to the projection direction of the projection unit is larger than the angle of an end of the projection plane with respect to the projection direction of the projection unit, in the generation step, the projection data whose difference from the image data is larger when second information representing a second degree of bending larger than a first degree of bending is acquired than when first information representing the first degree of bending is acquired is generated.

14. A computer-readable storage medium storing a program that causes a computer to generate projection data based on image data, the program comprising:
an image acquisition step of acquiring the image data;
an information acquisition step of acquiring information about a shape of a projection plane of an image to be projected by a projection unit; and
a generation step of generating the projection data to be used for projection using the image data acquired in the image acquisition step and the information acquired in the information acquisition step.

15. The medium according to claim 14, wherein in the generation step, out of the image data, image data corresponding to a region where an angle made by the projection plane and a projection direction of the projection unit is not less than a predetermined value is changed for generation of the projection data.

16. The medium according to claim 14, wherein when there exist a region where a ratio of a reflected light amount from the projection plane to a projection light amount by the projection unit is less than a threshold, and a region where the ratio is not less than the threshold, in the generation step, a luminance of image data corresponding to the region where the ratio is not less than the threshold out of the image data is lowered for generation of the projection data.

17. The medium according to claim 14, wherein the information is information about a degree of bending of the projection plane, and
when an angle of a center of the projection plane with respect to the projection direction of the projection unit is larger than the angle of an end of the projection plane with respect to the projection direction of the projection unit, in the generation step, the projection data whose difference from the image data is larger when second information representing a second degree of bending larger than a first degree of bending is acquired than when first information representing the first degree of bending is acquired is generated.
